(19) United States
(12) Patent Application Publication
(10) Pub. No.: US 2005/0052567 A1
(43) Pub. Date: Mar. 10, 2005

(54) Digital Camera

(75) Inventors: Wei-Cheng Huang, Taipei County (TW); Peng-Yuan Lee, Taipei County (TW)

Correspondence Address: BACON & THOMAS, PLLC, 625 SLATERS LANE, FOURTH FLOOR, ALEXANDRIA, VA, 22314, US

(73) Assignee: CHICONY ELECTRONICS CO. LTD, Taipei (TW)

(21) Appl. No.: 10/715,560

(22) Filed: Nov. 19, 2003

(30) Foreign Application Priority Data
Sep. 9, 2003 (TW) 92216247

(51) Int. Cl. H04N 5/225

(52) U.S. Cl. 348/373

(57) ABSTRACT

A digital camera is provided, which includes a case with a front cover; a lens located on one side of the case; a lens cover with a hollow-engraved label, which may be of a specific text or pattern; and a light emitting object located below the lens cover under the operation mode. While under the operation mode, the light emitting object emits light through the hollow-engraved label on the lens cover, so that the digital camera can be used in a location without sufficient light, and enhances image recognition for operation.

### BACKGROUND OF THE INVENTION

1.

Field of the Invention

The present invention relates to a digital camera, and particularly to a digital camera having a lens cover with a hollow-engraved label. The digital camera uses a light emitting object to shed light on the hollow-engraved portion of the lens cover so that the light will run through the hollow-engraved portion on the lens cover. In this way, the image recognition is enhanced while using without sufficient light.

2. Description of the Related Art

The digital camera is often used to establish web pages, take memorable photos, and establish photo databases, presenting great commercial potential. Its main components include an image sensing device (CCD Sensor or CMOS), an ASIC for high speed digital signal processing, a memory card, a display card, a lens etc. Compared with conventional cameras, advantages of digital cameras include no need for films and photo development, better mobility and cost saving. From the view of the emerging consumer electronic products, the product is a fully electronic camera capable of immediate development and printing; and from the view of the computer peripheral products, it can be treated as a 3D image input equipment (such as a scanner), with the possibility to replace some of the middle and low levels of image scanners. Further, from the view of the communication products, most digital cameras are capable of capturing video signals, so that they can serve the function as video cameras with reasonable prices by adding the video capture card upon other image-transmitting device.

The conventional digital cameras are mainly divided into two types: one is the fashionable type, which has many functions though impractical; another one is the practical type, which has simple functions and is easy to operate. However, the external architectures of both types are of little differences, monotonous without much variety. Also, for the conventional camera, a light spot is configured above the lens of the digital camera to signal the mode of the self-timer for self-portraits, wherein the light spot will flash to inform the user that the camera is under the self-timer mode.

Nevertheless, the light spot for the self-timer of the conventional digital camera is only an inconspicuous spot. If the user is taking a self-portrait at a far distance or at a location without clear sight, it is difficult to read the light spot, and the user will not know if the camera has completed the task of photo-taking. This disadvantage needs to be improved.

### SUMMARY OF THE INVENTION

The object of the present invention is to provide a digital camera, which uses a light emitting object to illuminate the hollow-engraved portion of the lens cover so that the light will run through the hollow-engraved portion on the lens cover and the user can easily recognize the operation modes when the light is insufficient.

The other object of the present invention is to provide a digital camera, which uses a light emitting object with multi-color LED so that the digital camera will exhibit the light emitting object with different colors according to different operation modes.

To achieve the above-mentioned objects, the digital camera includes a case with a front cover; a lens located on one side of the case; a lens cover with a hollow-engraved label which may be of a specific text or pattern; and a light emitting object which is located below the lens cover under the operation mode, wherein the light emitting object emits light through the hollow-engraved label on the lens cover.

The case is configured with a controlling circuit and a driving device.

The hollow-engraved label of the lens cover can further be of a specific text or pattern, in which the pattern may be a logo or other image creation.

The hollow-engraved label of the lens cover can be a laser-engraved label.

The light emitting object can be a light emitting diode (LED), or a light emitting object made of other light emitting material.

The light emitting object flashes under the self-timer mode.

The number of the light emitting objects is scalable according to different operation modes.

The light emitting object can use multi-color LED to exhibit different colors according to different operation modes.

The light emitting object can emit green light under the film taking mode, and red light under the photo taking mode.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 is an exploded 3D diagram for turning off the digital camera according to the present invention.

FIG. 2 is an exploded 3D diagram for turning on the digital camera according to the present invention.

FIG. 3 is a 3D assembly diagram for turning on the digital camera according to the present invention.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

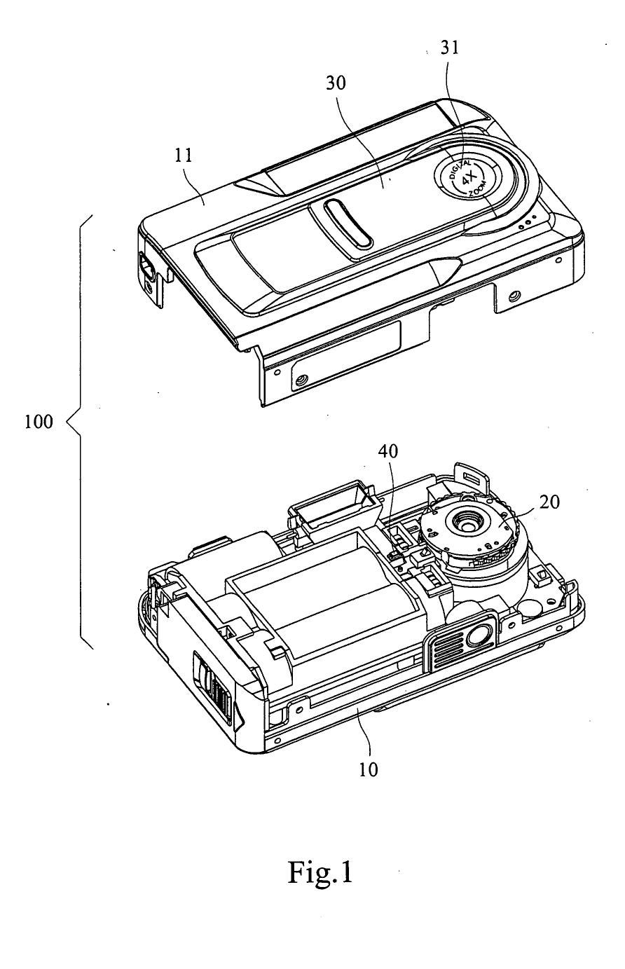

FIG. 1 shows an exploded 3D diagram for turning off the digital camera of the present invention. The digital camera 100 with a hollow-engraved label on the lens cover of the present invention includes a case 10 with a front cover 11; a lens 20 located on one side of the case 10; a lens cover 30 which is located on the front cover 11, and has a hollow-engraved label 31; and a light emitting object 40 which is located beside the lens 20 and below the lens cover 30 under the operation mode.

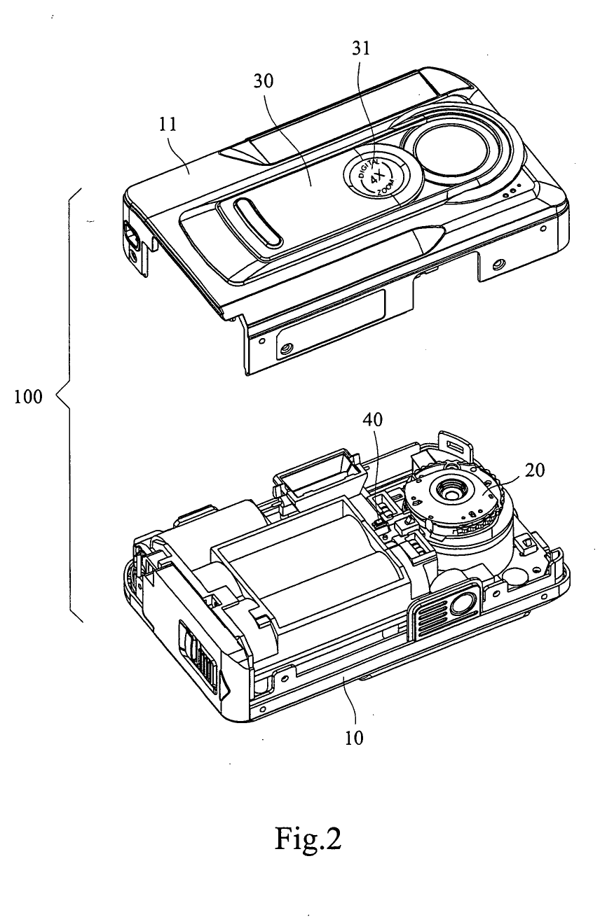

Next, with reference to FIG. 1 and FIG. 2 FIG. 2 shows an exploded 3D diagram for turning on the digital camera of the present invention, wherein the case 10 is configured with a controlling circuit and a driving device. The controlling circuit actuates the driving device by a control button. The hollow-engraved label 31 on the lens cover 30 of the present invention is a laser-engraved label, indicating that it is a variable digital lens with 4× focus length. The light emitting object 40 is a light emitting diode (LED) or other light emitting object made of other light emitting material.

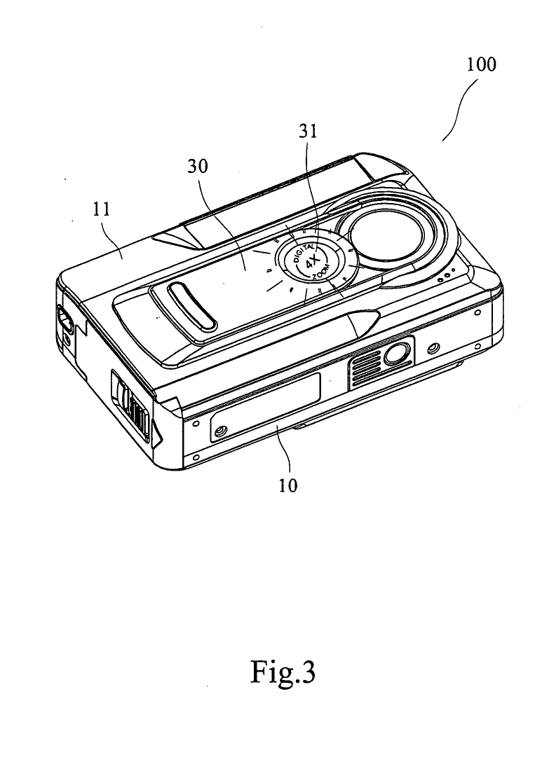

With reference to FIG. 3 and FIG. 2, FIG. 3 shows a 3D assembly diagram for turning on the digital camera of the present invention. To turn on the digital camera 100, first slide open the lens cover 30 covering the lens 20 along the horizontal direction to reveal the lens 20 completely. At this time, the opened lens cover 30 activates the controlling circuit and turn on the light emitting object 40. Then the light run through the hollow-engraved label 31 of the lens cover 30 to exhibit a bright and conspicuous 3D vision through, so that the user can clearly understand that the digital camera 100 is under the standby mode, as shown in FIG. 2. To turn off the digital camera 100, the lens cover 30 is moved horizontally until the lens cover 30 completely cover the lens 20. Then the light emitting object 40 goes off, and the digital camera 100 is switched to the off mode, as shown in FIG. 1.

The hollow-engraved label 31 of the lens cover according to the present invention may further be of a specific text or pattern. The pattern may be a logo or other created images, so that the hollow-engraved pattern may exhibit different styles.

The light emitting object 40 of the digital camera 100 according to the present invention may further be configured to meet functional requirements. For example, under a self-timer mode, the light emitting object 40 can be configured to flash, so that the flashing light emitting object 40 shines through the hollow-engraved label 31 on the lens cover 30 under the self-timer mode. Thus, the user can clearly understand that the camera is on by the flash light, while the light emitting object 40 goes off, it then signals the off mode of the digital camera.

Moreover, the digital camera 100 having the lens cover with hollow-engraved label according to the present invention may further increase the number of light emitting objects 40. For example, the camera can use the light emitting object 40 made of multi-color LED to exhibit different colors according to different operation modes, such as showing a green light in the film recording mode, and a red light in the photo taking mode etc. Thus, the user can clearly understand under which mode the camera is by the color of light projecting on the hollow-engraved label 31 of the lens cover 30 by the light emitting object 40, and thereby enhance the recognition for the user operation.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

1. A digital camera comprising
a case;
a lens;
a light emitting object; and
a lens cover;
characterized in that said lens cover located in front of said light emitting object under the operation mode, said lens cover having a hollow-engraved label, and said light emitting object shedding light on said hollow-engraved label on said lens cover as said lens cover being under the operation mode.

2. The digital camera of claim 1, wherein said case is configured with a controlling circuit and a driving device.

3. The digital camera of claim 1, wherein said hollow-engraved label of the lens cover can further be of a specific text or pattern, in which the pattern may be a logo or created images.

4. The digital camera of claim 3, wherein said hollow-engraved label of the lens cover can be a laser-engraved label.

5. The digital camera of claim 1, wherein said light emitting object can be a light emitting diode (LED), or can be made of other light emitting material.

6. The digital camera of claim 1, wherein said light emitting object flashes under the self-timer mode.

7. The digital camera of claim 1, wherein the number of said light emitting object can be increased according to different operation modes.

8. The digital camera of claim 7, wherein said light emitting object can use multi-color LED and exhibit different colors according to different operation modes.

9. The digital camera of claim 8, wherein said light emitting object can show a green light under the video recording mode, and a red light under the photo taking mode.
